(19) United States
(12) Patent Application Publication
(10) Pub. No.: US 2017/0257395 A1
(43) Pub. Date: Sep. 7, 2017

(54) METHODS AND DEVICES TO THWART EMAIL DISPLAY NAME IMPERSONATION

(71) Applicant: Vade Retro Techology Inc., San Francisico, CA (US)

(72) Inventor: Sébastien GOUTAL, Gravigny (FR)

(21) Appl. No.: 15/063,340

(22) Filed: Mar. 7, 2016

(51) Int. Cl. H04L 29/06

(52) U.S. Cl. CPC H04L 63/1483; H04L 63/1425; H04L 63/123

(57) ABSTRACT

A list of known addresses of electronic messages may be maintained, as may be a list of known display names of electronic messages. A list of blacklisted email addresses, which are always assumed to be fraudulent or malicious, may also be maintained. For each electronic message received by a user, it may be determined whether the address or display name looks suspicious; that is, whether the received email appears to impersonate a known email address or a known display name. The user may be warned if a received electronic message is determined to be or may likely be or contain an illegitimate or spoofed address or display name.

### CROSS-REFERENCE TO RELATED APPLICATIONS

The present application is related in subject matter to commonly-owned and co-pending U.S. application Ser. No. 14/542,939 filed on Nov. 17, 2014 entitled “Methods and Systems for Phishing Detection”, which is incorporated herein by reference in its entirety. The present application is also related in subject matter to commonly-owned and co-pending U.S. application Ser. No. 14/861,846 filed on Sep. 22, 2015 entitled “Detecting and Thwarting Spear Phishing Attacks in Electronic Messages”, which is also incorporated herein by reference in its entirety.

### BACKGROUND

Spear phishing is an email that appears to be from an individual that you know. But it is not. The spear phisher knows your name, your email address, your job title, your professional network. He knows a lot about you thanks, at least in part, to all the information available publicly on the web.

### BRIEF DESCRIPTION OF THE DRAWINGS

FIG. 1 is a table showing examples of legitimate email address and spoofed email addresses.

FIG. 2 is a table showing a legitimate display name of an email address and spoofed display names of a suspect email address, according to one embodiment.

FIG. 3 is a table showing display names and normalized display names, according to one embodiment.

FIG. 4 is a table showing the successive steps of the display name normalization process, according to one embodiment.

FIG. 5 is a table showing a legitimate email address, spoofed email address and the Levenshtein distance between legitimate email address and the spoofed email addresses, according to one embodiment.

FIG. 6 is a table showing a legitimate display name, spoofed display names and the Levenshtein distance between the spoofed normalized display name and the legitimate normalized display name, according to one embodiment.

FIG. 7 is a flow chart of a method according to one embodiment.

FIG. 8 is a system configured according to one embodiment.

FIG. 9 is a block diagram of a computing device configured according to one embodiment.

### DETAILED DESCRIPTION

Spear phishing is a growing threat. It is, however, a very different attack from a phishing attack. The differences include the following:
The target of a spear phishing attack is usually the corporate market, and especially people who have access to sensitive resources of the company. Typical targets include accountants, lawyers, top management executives and the like. In contrast, phishing targets all end users;
A spear phishing attack is thoroughly prepared through an analysis of the intended target. Social networks (Facebook, Twitter, LinkedIn . . . ), company websites and media, in the aggregate, can produce a lot of relevant information about someone. The spear phishing attack will be unique and highly targeted. In contrast, phishing attacks indiscriminately target thousands of people.

The first step of a spear phishing attack may come in the form of an electronic message (e.g., an email) received from what appears to be a well-known and trusted individual, such as a coworker, colleague or friend. In contrast, a (regular, non-spear) phishing email appears to be from a trusted company such as, for example, PayPal, Dropbox, Apple and the like. The second step of a spear phishing attack has a different modus operando: a malicious attachment or a malicious Universal Resource Locator (URL) that is intended to lead the victim to install malicious software (malware) that will perform malicious operations (data theft . . . ) or just a text in the body of the email that will lead the victim to perform the expected action (wire transfer, disclosure of sensitive information and the like). A regular, non-spear phishing attack relies only on a malicious URL.

To protect a user from spear phishing attacks, a protection layer, according to one embodiment, may be applied for each step of the spear phishing attack. Against the first step of the phishing attack, one embodiment detects an impersonation. Against the second step of the phishing attack, one embodiment may be configured to detect the malicious attachment, detect the malicious URL and/or detect suspect text in the body of the email or other form of electronic message.

According to one embodiment, an attempted spear phishing attack be thwarted or prevented through detection of the impersonation. To prevent such an impersonation, according to one embodiment, when a user receives an electronic message from an unknown or what may look like a known sender, it may be determined whether the sender email address or display name look like a known contact of the user. If this is indeed the case, the user may be warned that there may be an impersonation.

To fully appreciate the embodiments described, shown and claimed, herein, it is necessary to understand the difference between an electronic or email address and a display name. The display name is what is usually displayed in the email client software to identify the recipient. It is typically the first name and the last name of the recipient of the email or electronic message. Consider the following From header:

From: John Smith <john.smith@gmail.com>

In this case, the display name is “John Smith” and the email address is “john.smith@gmail.com”.

The protection layer, according to one embodiment, may comprise the following activities:
1. Manage, for the protected user, a list of his or her known contacts email addresses called KNOWN_ADDRESSES;
2. Manage, for the protected user, a list of the display names of his or her known contacts, called KNOWN_DISPLAY_NAMES;
3. Manage, for the protected user, a list of blacklisted email addresses (emails that are always assumed to be fraudulent or malicious), called BLACKLISTED_ADDRESSES;
4. Determine, for each incoming email or electronic message, whether the address or display name looks suspicious; that is, whether the received email appears to impersonate a known email address or a known display name; and
5. Warn the end user if a received email or electronic message is determined to be or may likely be or contain an email address or a display name impersonation.

The following is a software implementation showing aspects of one embodiment, as applied to email addresses.

function: process_email
input:

| | |
|---|---|
| • | email: email received. |
| • | known_addresses: list of known email addresses. each email |

address is a lowercase string.

| | |
|---|---|
| • | known_display_names: list of known display names. each |

display name is a lowercase string that has been normalized. Refer to
normalize_display_name( ).

| | |
|---|---|
| • | blacklisted_addresses: list of blacklisted email addresses. |

each email address is a lowercase string.
output:

| | |
|---|---|
| • | true if email has to be dropped, false otherwise |

```
# extract address from From header [1]
address = email.from_header.address
address = lowercase(address)
# if address is blacklisted, drop email
if address in blacklisted_addresses:
  return true
# if address is already known, it is not suspect
if address in known_addresses:
  return false
# extract display name from From header [1] and normalize it
display_name = email.from_header.display_name
display_name = normalize_display_name(display_name)
# if address or display name is suspicious, warn user
if is_address_suspicious(address, known_addresses) or
  is_display_name_suspicious(display_name, known_display_names):
  # decision is confirmed or denied
  decision = warn_end_user(address, display_name)
  if decision is confirmed:
```

```
  blacklisted_addresses.append(address)
  return true
```

else if decision is denied:

```
  known_addresses.append(address)
  if display_name not in known_display_names:
```

known_display_names.append(display_name)

return false

```
# otherwise add address and display name
else:
  known_addresses.append(address)
  if display_name not in known_display_names
```

known_display_names.append(display_name)

return false

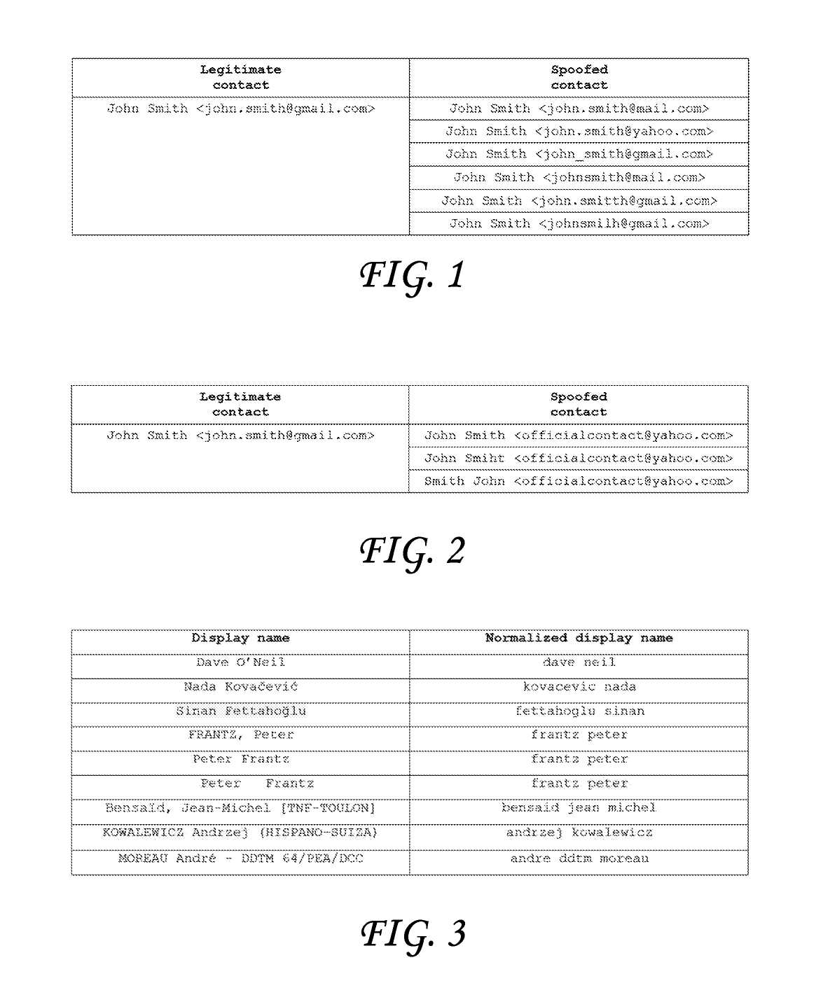

Several examples of email address impersonation or spoofing are shown in FIG. 1. As shown, the legitimate email address is john.smith@gmail.com. In the first row, the legitimate john.smith@gmail.com has been spoofed by replacing the domain “gmail.com” with “mail.com”. In the second row, “gmail.com” has been replaced with another legitimate domain; namely, “yahoo.com”. Indeed, the user may not remember whether John Smith's email is with gmail.com, mail.com or yahoo.com or some other provider, and may lead the user to believe that the email is genuine when, in fact, it is not. In the third row, the period between “john” and “smith” has been replaced by an underscore which may appear, to the user, to be a wholly legitimate email address. The fourth row shows another variation, in which the period between “john” and “smith” has been removed, which change may not be immediately apparent to the user, who may open the email believing it originated from a trusted source (in this case, john.smith@gmail.com). In the fifth row, an extra “t” has been added to “smith” such that the email address is john.smitth@gmail.com, which small change may not be noticed by the user. Lastly, the sixth row exploits the fact that some letters look similar, such as a “t” and an “l”, which allows an illegitimate email address of johnsmilh@gmail.com to appear legitimate to the casual eye. As may be appreciated, there has been a fair amount of creativity displayed in spoofing email addresses.

Several examples of display name impersonation are shown in FIG. 2. Email clients, such as Microsoft Outlook, Apple Mail, Gmail, to name but a few, are configured to display, by default, the display name, and may not necessarily display the email address itself in incoming emails. As shown therein, the legitimate contact is John Smith whose legitimate email address is john.smith@gmail.com. Here, the legitimate display name is “John Smith” and the legitimate email address associated with the legitimate display name “john Smith” is “john.smith@gmail.com”. The Spoofed contact column shows several possible spoofed contact display names, as well as an illegitimate email address of “officialcontact@yahoo.com”. In the first row, the display name is correct; namely “john Smith”, but is associated with the illegitimate email address of “officialcontact@yahoo.com”. The second row shows the same illegitimate email address, but the display name is subtly different; with a transposition of the last two letters of the contact “John Smiht”. This small change may not be noticed during a busy workday and the email may be treated as legitimate when, if fact, it is not. The third row of FIG. 2 also shows that the illegitimate display name includes transposed last and first names.

Managing List of Known Contacts Email Addresses

According to one embodiment, a list may be managed, for the end user, of his or her known contacts email addresses called KNOWN_ADDRESSES. This list only contains known, trusted email addresses. In one implementation, all email addresses in this list are stored as lowercase.

The KNOWN_ADDRESSES list, according to one embodiment, may be initially fed by one or more of:

1. The email addresses stored in the address book of the end user. However, if the email address book exceeds ADDRESS_BOOK_MAX_SIZE (default value: 1,000 but may be higher or lower), the address book may not be used for performance and accuracy reasons. Address books of very large companies can become that large if, for example, they maintain a single address book for the contact information of all of their employees.

2. The email addresses stored in “From” header of emails or electronic messages received by the end user with the exception, according to one embodiment, of automated emails such as email alerts, newsletters, advertisements or any email that has been sent by an automated process.

3. The email addresses of people to whom the end user has sent an email.

The KNOWN_ADDRESSES list may be updated in one or more of the following cases:

1) When the address book is updated.

2) When the end user receives an email from a non-suspect new contact with the exception, according to one embodiment, of automated emails such as email alerts, newsletters, advertisements or any email that has been sent by an automated process.

3) When the end user sends an email to a new contact.

Managing List of Known Contacts Display Names

A list of the user's known contacts may be managed for the user. This list may be called KNOWN_DISPLAY_NAMES. According to one embodiment, this list may only contain normalized display names, which may be stored as lowercase strings. Normalization, in this context, refers to one or more predetermined transformations to which all display names are subjected to, to enable comparisons to be made.

The KNOWN_DISPLAY_NAMES, according to one embodiment, may be initially fed by one or more of:

1. The display names stored in the address book of the end user. However, if the email address book exceeds ADDRESS_BOOK_MAX_SIZE (default value: 1000 but may be higher or lower), the address book may not be used for performance and accuracy reasons.

2. The display names stored in “From” header of emails received by the end user with the exception of, according to one embodiment, automated emails such as email alerts, newsletters, advertisements or any email that has been sent by an automated process.

3. The display names of people to whom the end user has sent an email.

The KNOWN_DISPLAY_NAMES may then be updated, according to one embodiment, in one or more of the following cases:
1) When the address book is updated.
2) When the end user receives an email from a known or non-suspect new contact with the exception of, according to one embodiment, automated emails such as email alerts, newsletters, advertisements or any email that has been sent by an automated process.
3) When the end user sends an email to a new contact.

Normalizing Display Names

The display name, according to one embodiment, may be normalized because:
The positions of first name, middle name and last name may vary;
One or more non-significant extra characters may be present: comma, hyphen and the like;
The letter case may vary;
Diacritical marks (such as, for example, é, è, ö, ï, \check{c}, ć) may be present; and/or
In the case of a corporate email address, extra information related to the company and its organization may be present: name of the company, department, position and the like.

There may be other reasons to normalize display names. FIG. 3 shows examples of display names normalization, according to embodiments. As shown therein, the “O'” in Dave O'Neil may be removed to render the normalized “dave neil”. The diacritical marks in proper names may be removed. In this manner, Nada Kova\check{c}ević and Sinan Fettaho\check{g}lu become, respectively, “kovacevic nada” and “fettahoglu Sinan”. All uppercase letters may be rendered in lower case and all punctuation (e.g., symbols including, for example, ! ″ # $ % & ′ ( ) [ ] * + , . / : ; < = > ? @ \ ̂ _ ’ { | } ˜ -) may be removed, such that both FRANTZ, Peter and Peter Frantz may be normalized to the same “frantz peter” and stored in a Display Names database in normalized form. This also illustrates that more than one version of the same name may be associated with a single normalized version of the name. Also, extraneous information, such as [TNF TOULON], (HISPANO-SUIZA) and −64/PEA/DCC may be removed and not included in the display name. In this manner, Bensaïd, Jean-Michel [TNF-TOULON], KOWALEWICZ Andrzej (HISPANO-SUIZA) and MOREAU André-DDTM 64/PEA/DCC become, after normalization, “bensaid jean”, “michel andrzej kowalewicz” and “andre ddtm moreau”, respectively.

According to one embodiment, the normalization may be carried out as follows or according to aspects of the following:

function: normalize_display_name
input:

- display_name : string

output:

- normalized_display_name : string

# lowercase
display_name.to_lowercase( )
# remove content between ( ) and [ ], including ( ) and [ ] characters
# this content is typical of a company and its organization
# for example: KOWALEWICZ Andrzej (HISPANO-SUIZA)
display_name.remove_content_between_parenthesis( )
display_name.remove_content_between_brackets( )
# remove diacritical marks from characters like é, è, ö, ï, \check{c}, ć...
display_name.remove_diacritical_marks( )
# replace punctuation characters by a single space
# punctuation characters are: !″#$%&′( )[ ]*+,./:;<=>?@\\hat{ }_\grave{ }{|}~-
display_name.replace_punctuation_characters_by_space( )
# replace multiples spaces with a single space
display_name.remove_extra_space_characters( )
# replace heading and trailing spaces if any
display_name.remove_heading_space( )
display_name.remove_trailing_space( )
# tokenize display name
# we break the display name into a list of tokens
# we use space character as the separator
display_name_tokens = display_name.split(’ ’)
# we remove tokens whose length is smaller or equal to two characters
display_name_tokens = remove_small_tokens( )
# we keep the 3 longest tokens
# if two tokens have the same length, we keep the first one encountered
# i.e. we favor the left part of the display name
display_name_tokens = keep_longest_tokens( )
# we sort the tokens alphatically
display_name_tokens.sort( )
# finally, we join the tokens
normalized_display_name = display_name_tokens.join( )
return normalized_display_name

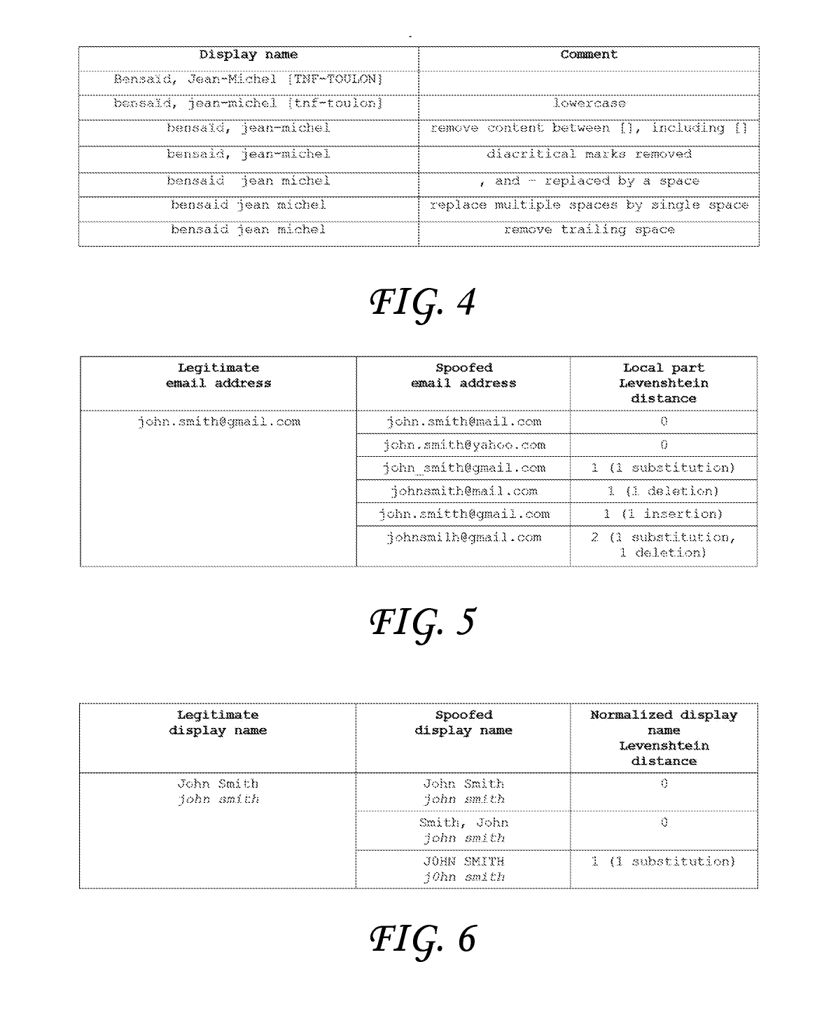

As an example, FIG. 4 shows successive exemplary transformations of the exemplary name Bensaïd, Jean-Michel [TNF-TOULON] when normalization is carried out, according to one embodiment. As shown therein, the original name, Bensaïd, Jean-Michel [TNF-TOULON] may be normalized, in one embodiment, by forcing all letter to be lowercase, resulting in “bensaïd, jean-michel [tnf-toulon]”, as shown in the second row of the table shown in FIG. 4. Then, the content between the brackets may be removed, including the brackets themselves, resulting in “bensaïd, jean-michel”. The diacritical marks may then be removed, such as the umlaut over the “i” in bensaïd. Selected symbols such as dashes “-”, may be replaced by a space, as shown in the fifth row of FIG. 4. Continuing the normalization process, multiple spaces between names may be replaced by a single space (row 6) and any trailing spaces may be removed, as shown in the last row of FIG. 4. The normalized version of Bensaïd, Jean-Michel [TNF-TOULON] may, therefore, be rendered as “bensaid jean michel”.

Managing List of Blacklisted Email Addresses

According to one embodiment, a list of blacklisted email addresses called BLACKLISTED_ADDRESSES may be managed for the user. This list of blackmailed email addresses will only contain email addresses that are always considered to be illegitimate and malicious. In one implementation, all email addresses in this blackmailed email address list will be stored as lowercase. If an email is sent by a sender whose email address belongs to BLACKLISTED_ADDRESSES, then the email will be dropped and will not be delivered to the end user, according to one embodiment. Other actions may be taken as well, or in place of dropping the email.

Detecting a Suspect Email Address

When the end user receives an electronic message such as an email, a determination is made whether the electronic address thereof is known, by consulting the KNOWN_ADDRESSES list. If the email address of the email's sender is present in the KNOWN_ADDRESSES list, the email address may be considered to be known. If, however, the email address of the sender is not present in the KNOWN_ADDRESSES list, the sender's email address is not considered to be known. In that case, according to one embodiment, a determination may be made to determine whether the email address resembles or “looks like” a known address.

An email address is made up of a local part, a @ symbol and a domain part. The local part is the left side of the email address, before the @ symbol. For example, “john.smith” is the local part of the email address john.smith@gmail.com. The domain is located at the right side of the email address, after the @ symbol. For example, “gmail.com” is the domain of the email address john.smith@gmail.com.

According to one embodiment, an email address may be considered to be suspect if the following conditions are met:
The email address is not in KNOWN_ADDRESSES list; and
The local part of the email address is equal or close to the local part of an email address record in the KNOWN_ADDRESSES list.

One embodiment utilizes the Levenshtein distance (a type of edit distance). The Levenshtein distance operates between two input strings, and returns a number equivalent to the number of substitutions and deletions needed in order to transform one input string (e.g., the local part of the received email address) into another (e.g., the local part of an email address in the KNOWN_ADDRESSES list). One embodiment, therefore, computes a string metric such as the Levenshtein distance to detect if there has been a likely spoofing of the local part of the received email address. The Levenshtein distance between two sequences of characters is the minimum number of single-character edits (i.e. insertions, deletions or substitutions) required to change one sequence of characters into the other. Other string metrics that may be used in this context include, for example, the Damerau-Levenshtein distance. Others may be used to good benefit as well, such as the Jaccard distance or Jaro-Winkler distance, for example.

FIG. 5 illustrates the Levenshtein distance, as applied to the local part of a received email message. Indeed, FIG. 5 is a table showing a legitimate email address, a spoofed email addresses and a calculated string metric (e.g., a Levenshtein distance) between the two, according to one embodiment. In the first row of the table of FIG. 5, the Levenshtein distance between the legitimate email address and the address in the Spoofed email address column is zero, meaning that they are the same and that no insertions, deletions or substitutions have been made to the local part. In the second row, the spoofed email addresses' domain is yahoo.com, whereas the legitimate address' domain is gmail.com. The spoofed email address, therefore, would not be present in the KNOWN_CONTACTS list, even though the Levenshtein distance between the local part of the legitimate email and the local part of the spoofed email is zero, meaning that they are identical. As both conditions are met (the email address is not in the KNOWN_CONTACTS list and the local part of the email address is equal or close to the local part of an email address of the KNOWN_CONTACTS list), the received john.smith@yahoo.com email would be considered to be suspect or at least likely illegitimate. The third row of the table in FIG. 5 shows that the Levenshtein distance between the legitimate email address and the spoofed email address is 1. In this case, the difference between the two local parts of the legitimate and spoofed email addresses is a single substitution of an underscore for a period. Similarly, the fourth row of the table in FIG. 5 shows that the Levenshtein distance between the legitimate email address and the spoofed email address is 1. In this case, the difference between the two local parts of the legitimate and spoofed email addresses is a single deletion of period in the local part of the received email address. The fifth row of the table in FIG. 5 shows that the Levenshtein distance between the legitimate email address and the spoofed email address is 1 as well. In this case, however, the difference between the two local parts of the legitimate and spoofed email addresses is a single insertion of an extra letter “t” in the local part. Lastly, the sixth row of the table in FIG. 5 shows that the Levenshtein distance between the legitimate email address and the spoofed email address is 2. Indeed, the difference between the two local parts of the legitimate and spoofed email addresses is a single insertion and a single deletion, as the period has been deleted and an “1” has been substituted for the “t” in the local part.

According to one embodiment, the local part of the email address may be considered suspect if the Levenshtein distance d (or some other metric d) between the local part of the email address and the local part of an email address of a record in the KNOWN_ADDRESSES list is such that:
d≦LEVENSHTEIN_DISTANCE_THRESHOLD

This evaluation of the local part of a received email against the local part of a record in the KNOWN_ADDRESSES list may be carried as follows:

function: is_address_suspicious
input:

| | |
|---|---|
| - | address: address to test. lowercase string. |
| - | known_addresses: list of known email addresses. each email |

address is a lowercase string.
output:

| | |
|---|---|
| - | true if suspect, false otherwise |

# these parameters can be configured according to the operational
conditions and security policy
levenshtein_distance_threshold = 2
localpart_min_length = 6
# if the localpart is too short, it is not relevant
if address.localpart.length < localpart_min_length :

return false

# otherwise we check each email address of known email addresses
for each known_address in known_addresses:

d = levenshtein_distance(address.localpart,

known_address.localpart)

if d >=0 and d <= localpart_levenshtein_distance_threshold:

return true

# email address is not suspect
return false

It should be noted that the parameters levenshtein_distance_threshold and localpart_min_length may be configured according to the operational conditions at hand and the security policy or policies implemented by the company or other deploying entity.

For example, if the levenshtein_distance_threshold is increased, then a greater number of spoofing attempts may be detected, albeit at the cost of raising a greater number of potentially non-relevant warning messages that are received by the user. The default values provided above should fit most operational conditions. As an alternative to Levenshtein distance, the Damerau-Levenshtein distance may also be used, as may other metrics and/or thresholds.

Detecting a Suspect Display Name

According to one embodiment, a string metric such as, for example, the Levenshtein distance may also be used to detect whether a display name has been spoofed or impersonated.

FIG. 6 shows examples, with the normalized display name being shown in italics. As shown therein, the legitimate display name for John Smith is “john smith”, shown in italics in the table shown in FIG. 6. The spoofed display names may be the same as the legitimate, normalized display name “john smith”, as the normalized display name Levenshtein distance is 0 in the cases shown in the first two rows. For example, the display name could normalize to a display name contained in the KNOWN_DISPLAY_NAMES list, but the email address could be spoofed. In the third row of the table in FIG. 6, the Levenshtein distance of the spoofed display name J0hn SMITH, normalized as “j0hn smith” may be 1, as a zero was substituted for the letter “o” in the name “John”.

The detection of a suspect display name may be carried out, according to one embodiment, as follows:

function: is_display_name_suspicious
input:

| | |
|---|---|
| - | display_name: normalized display name to test. lowercase |

string.

| | |
|---|---|
| - | known_display_names: list of known normalized display |

names. each normalized display name is a lowercase string.
output:

| | |
|---|---|
| - | true if suspect, false otherwise |

# these parameters can be configured according to the operational
conditions and security policy
levenshtein_distance_threshold = 2
display_name_min_length = 10
# case of too short display name
if display_name.length < display_name_min_length:

return false

# we check each display name of known display names
for each known_display_name in known_display_names:

d = levenshtein_distance(display_name, known_display_name)
if d <= levenshtein_distance_threshold:
return true

# display name is not suspect
return false

It is to be understood that parameters such as levenshtein_distance_threshold and display_name_min_length may be configured according to the prevailing operational conditions and security policy or policies of the company or other deploying entity.

For example, if the levenshtein_distance_threshold or other metric or threshold is increased, a greater number of spoofing attempts may be detected, but at the possible cost of a greater number of non-relevant warnings that may negatively alter the user experience. The default values provided, however, should fit most operational conditions. As an alternative to Levenshtein distance [2], the Damerau-Levenshtein distance or other metrics or thresholds may be utilized to good effect.

Warning the End User

If it is determined that the received email impersonates a known email address or display name, a message may be generated to warn the end user, who must then make a decision:
The user may confirm that the email address is indeed suspect. That email address may then be added to the BLACKLISTED_ADDRESSES list and the email may be dropped or some other predetermined action may be taken.
The user, alternatively, may deny that the email address is suspect, whereupon the email address may be added to the KNOWN_ADDRESSES list and the display name may be added, if necessary, to the KNOWN_DISPLAY_NAMES list and the email is delivered to the end user.

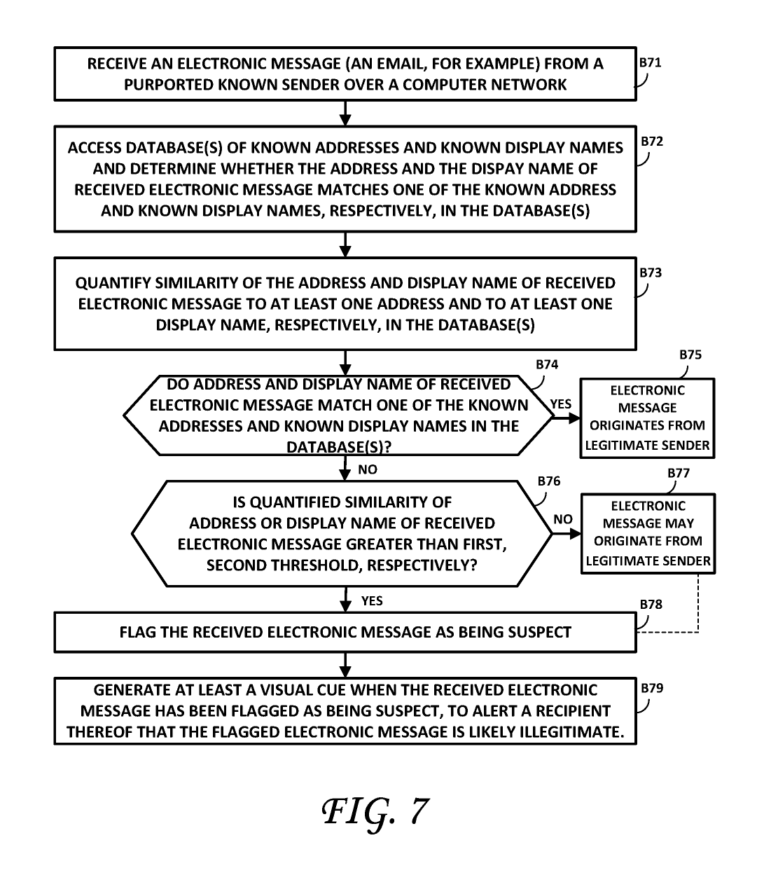

FIG. 7 is a flowchart of a method according to one embodiment. As shown therein, block B71 calls for receiving an electronic message from a purported known sender over a computer network. In one implementation, the electronic message may comprise an address and a display name. B72 calls for accessing one or more database(s) of known addresses and known display names. The database or databases may be stored locally or accessed over a computer network. The database or databases, moreover, may be stored locally and updated over the computer network. B72 also calls for determining whether the address and the display name of the received electronic message match one of the known addresses and known display names, respectively, in the database(s) of known addresses and known display names. Thereafter, in block B73, the similarity of the address and of the display name of the received electronic message to at least one address and to at least one display name, respectively, in the database(s) may be quantified.

At B74 in FIG. 7, according to one embodiment, it may be determined whether the address and display name of the received electronic message match an address and a display name (display name associated with the address) of the received electronic, respectively, in the database(s) of known addresses and known display names. If yes, the electronic message is determined to be legitimate, as originating from a legitimate sender, as shown at B75. If not, it may be determined whether, as shown at B76, the quantified similarity of the address of the received electronic message is greater than a first threshold or whether the quantified similarity of the display name of the received electronic message is greater than a second threshold. If not, the electronic message may be legitimate, as shown at B77. If the quantified similarity of the address of the received electronic message is greater than a first threshold or if the quantified similarity of the display name of the received electronic message is greater than a second threshold (YES branch of B76), the received electronic message may be flagged as being suspect, as shown at B78. In one implementation, B78 may also be carried out if the quantified similarities are nonzero, but less than the first or second threshold amounts, indicating somewhat decreased confidence that the electronic message is indeed legitimate. An informative message may then be generated for the user, which may cause him or her to take a second look at the electronic message before opening it. Lastly, as shown at B79, a user-perceptible cue (e.g., visual, aural or other) may be generated when the electronic message has been flagged as being suspect, to alert the user recipient that the flagged electronic message may be illegitimate. The electronic message may then be dropped, deleted or otherwise subjected to additional treatment (such as, for example, deleting or guaranteeing).

FIG. 8 is a block diagram of a system configured for spear phishing detection, according to one embodiment. As shown therein, a spear phishing email server or workstation (as spear phishing attacks tend to be somewhat more artisanal than the comparatively less sophisticated phishing attacks) 802 (not part of the present spear phishing detection system, per se) may be coupled to a network (including, for example, a LAN or a WAN including the Internet), and, indirectly, to a client computing device 812's email server 808. The email server 808 may be configured to receive the email on behalf of the client computing device 812 and provide access thereto. A database 806 of known addresses may be coupled to the network 804. A Blacklist database 814 may also be coupled to the network 804. Similarly, a database 816 of known display names may be coupled to the network 804. A phishing detection engine 810 may be coupled to or incorporated within, the email server 808. Alternatively, some or all of the functionality of the spear phishing detection engine 810 may be coupled to or incorporated within the client computing device 812. Alternatively still, the functionality of the spear phishing detection engine 810 may be distributed across both client computing device 812 and the email server 808. According to one embodiment, the spear phishing detection engine 810 may be configured to carry out the functionality and methods described herein above and, in particular, with reference to FIG. 7. The databases 806, 814 and 816 may be merged into one database and/or may be co-located with the email server 808 and/or the spear phishing detection engine 810.

Any reference to an engine in the present specification refers, generally, to a program (or group of programs) that perform a particular function or series of functions that may be related to functions executed by other programs (e.g., the engine may perform a particular function in response to another program or may cause another program to execute its own function). Engines may be implemented in software and/or hardware as in the context of an appropriate hardware device such as an algorithm embedded in a processor or application-specific integrated circuit.

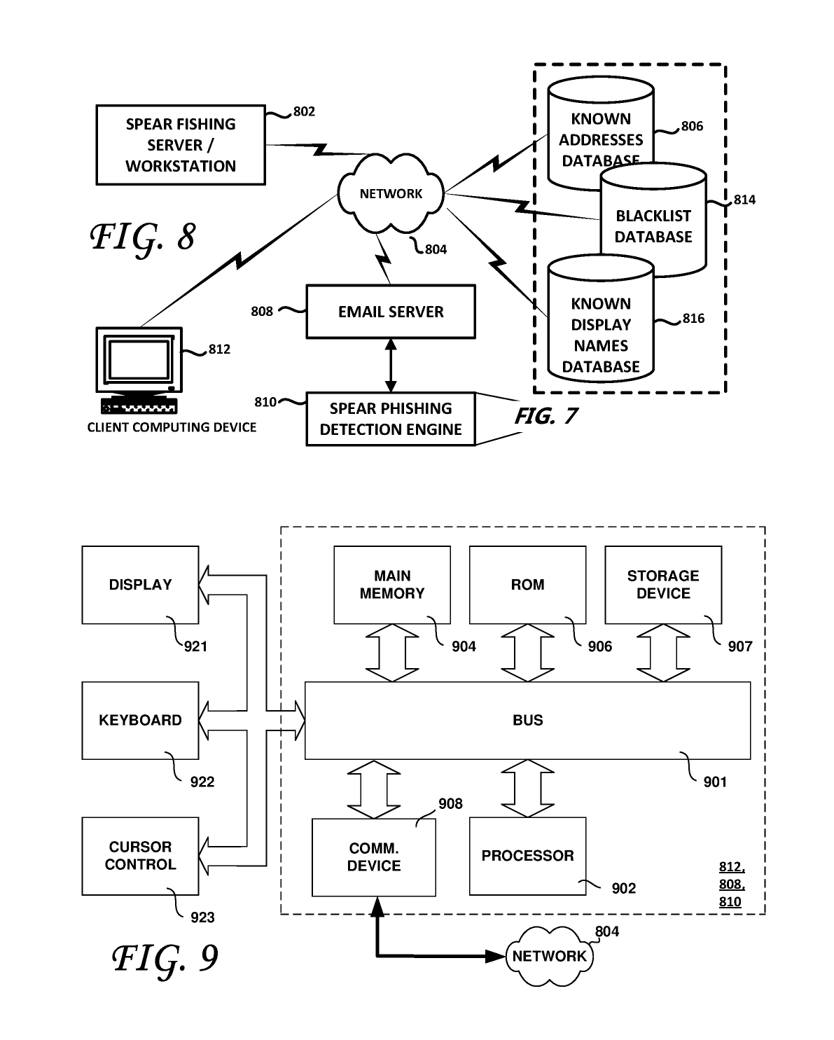

FIG. 9 illustrates a block diagram of a computing device such as client computing device 812, email (electronic message) server 808 or spear phishing detection engine 810 upon and with which embodiments may be implemented. Computing device 812, 808, 810 may include a bus 901 or other communication mechanism for communicating information, and one or more processors 902 coupled with bus 801 for processing information. Computing device 812, 808, 810 may further comprise a random access memory (RAM) or other dynamic storage device 904 (referred to as main memory), coupled to bus 901 for storing information and instructions to be executed by processor(s) 902. Main memory (tangible and non-transitory, which terms, herein, exclude signals per se and waveforms) 904 also may be used for storing temporary variables or other intermediate information during execution of instructions by processor 902. Computing device 812, 808, 810 may also may include a read only memory (ROM) and/or other static storage device 906 coupled to bus 901 for storing static information and instructions for processor(s) 902. A data storage device 907, such as a magnetic disk and/or solid state data storage device may be coupled to bus 901 for storing information and instructions—such as would be required to carry out the functionality shown and disclosed relative to FIGS. 1-7. The computing device 812, 808, 810 may also be coupled via the bus 901 to a display device 921 for displaying information to a computer user. An alphanumeric input device 922, including alphanumeric and other keys, may be coupled to bus 901 for communicating information and command selections to processor(s) 902. Another type of user input device is cursor control 923, such as a mouse, a trackball, or cursor direction keys for communicating direction information and command selections to processor(s) 902 and for controlling cursor movement on display 921. The computing device 812, 808, 810 may be coupled, via a communication interface (e.g., modem, network interface card or NIC) to the network 804.

Embodiments of the present invention are related to the use of computing device 812, 808, 810 to detect whether a received electronic message may be illegitimate as including a spear phishing attack. According to one embodiment, the methods and systems described herein may be provided by one or more computing devices 812,808, 810 in response to processor(s) 902 executing sequences of instructions contained in memory 904. Such instructions may be read into memory 904 from another computer-readable medium, such as data storage device 907. Execution of the sequences of instructions contained in memory 904 causes processor(s) 902 to perform the steps and have the functionality described herein. In alternative embodiments, hard-wired circuitry may be used in place of or in combination with software instructions to implement the described embodiments. Thus, embodiments are not limited to any specific combination of hardware circuitry and software. Indeed, it should be understood by those skilled in the art that any suitable computer system may implement the functionality described herein. The computing devices may include one or a plurality of microprocessors working to perform the desired functions. In one embodiment, the instructions executed by the microprocessor or microprocessors are operable to cause the microprocessor(s) to perform the steps described herein. The instructions may be stored in any computer-readable medium. In one embodiment, they may be stored on a non-volatile semiconductor memory external to the microprocessor, or integrated with the microprocessor. In another embodiment, the instructions may be stored on a disk and read into a volatile semiconductor memory before execution by the microprocessor.

While certain example embodiments have been described, these embodiments have been presented by way of example only, and are not intended to limit the scope of the embodiments disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the embodiments disclosed herein.

1. A computer-implemented method, comprising:
receiving, by a computing device, an electronic message from a purported known sender over a computer network, the electronic message comprising an address and a display name;
accessing, by the computing device, at least one database of known addresses and known display names and determining whether the address and the display name of the received electronic message match one of the known addresses and known display names, respectively, in the at least one database of known addresses and known display names;
quantifying, by the computing device, a similarity of the address and of the display name of the received electronic message to at least one address and to at least one display name, respectively, in the at least one database of known addresses and known display names;
determining, by the computing device, the received electronic message to be legitimate when the address and the display name of the received electronic message are determined to match one of the known addresses and known display names, respectively, in the at least one database of known addresses and known display names;
flagging, by the computing device, the received electronic message as being suspect:
when either the address or the display name of the received electronic message does not match an address or a display name, respectively, in the at least one database of known addresses and known display names; and
when the quantified similarity of the address of the received electronic message is greater than a first threshold value or when the quantified similarity of the display name is greater than a second threshold value; and
generating, by the computing device, at least a visual cue on a display of the computing device, when the received electronic message has been flagged as being suspect, to alert a recipient thereof that the flagged electronic message is likely illegitimate.

2. The computer-implemented method of claim 1, wherein the electronic message comprises an email.

3. The computer-implemented method of claim 1, wherein quantifying comprises calculating string metrics of differences between the address of the received electronic message and an address stored in the at least one database of known addresses and of known display names and between the display name of the received electronic message and a display name stored in the at least one database of known addresses and of known display names.

4. The computer-implemented method of claim 1, wherein quantifying comprises calculating Levenshtein distances between
the address of the received electronic message and an address stored in the at least one database of known addresses and of known display names; and
between the display name of the received electronic message and a display name stored in the at least one database of known addresses and of known display names.

5. The computer-implemented method of claim 1, further comprising prompting for a decision confirming the flagged electronic message is suspect or a decision denying that the flagged electronic message is suspect.

6. The computer-implemented method of claim 5, further comprising dropping the flagged electronic message when the prompted decision is to confirm that the flagged electronic message is suspect and delivering the flagged electronic message when the prompted decision is to deny that the flagged electronic message is suspect.

7. The computer-implemented method of claim 1, wherein accessing also accesses a database of blacklisted senders of electronic messages and dropping the received electronic message if the address of the received electronic message matches an entry in the database of blacklisted senders of electronic messages.

8. The computer-implemented method of claim 1, wherein the display names stored in the at least one database of known addresses and known display names are normalized and wherein the method further comprises normalizing the display name of the electronic message before quantifying.

9. The computer-implemented method of claim 8, wherein normalizing further comprises transforming the received display name to at least one of make all lower case, remove all punctuation and diacritical marks, remove bracketed or parenthetical information and extra spaces.

10. (canceled)

11. A computing device configured to determine whether a received electronic message is suspect, comprising:
at least one hardware processor;
at least one hardware data storage device coupled to the at least one processor;
a network interface coupled to the at least one processor and to a computer network;
a plurality of processes spawned by said at least one processor, the processes including processing logic for:
receiving an electronic message from a purported known sender over the computer network, the electronic message comprising an address and a display name;
accessing at least one database of known addresses and known display names and determining whether the address and the display name of the received electronic message match one of the known addresses and known display names, respectively, in the at least one database of known addresses and known display names;
quantifying a similarity of the address and of the display name of the received electronic message to at least one address and to at least one display name, respectively, in the at least one database of known addresses and known display names;
determining the received electronic message to be legitimate when the address and the display name of the received electronic message are determined to match one of the known addresses and known display names, respectively, in the at least one database of known addresses and known display names;
flagging the received electronic message as being suspect:
when either the address or the display name of the received electronic message does not match an address or a display name, respectively, in the at least one database of known addresses and known display names; and
when the quantified similarity of the address of the received electronic message is greater than a first threshold value or when the quantified similarity of the display name is greater than a second threshold value; and
generating at least a visual cue when the received electronic message has been flagged as being suspect, to alert a recipient thereof that the flagged electronic message is likely illegitimate.

12. The computing device of claim 11, wherein the electronic message comprises an email.

13. The computing device of claim 11, wherein quantifying comprises calculating string metrics of differences between the address of the received electronic message and an address stored in the at least one database of known addresses and of known display names and between the display name of the received electronic message and a display name stored in the at least one database of known addresses and of known display names.

14. The computing device of claim 11, wherein quantifying comprises calculating Levenshtein distances between
the address of the received electronic message and an address stored in the at least one database of known addresses and of known display names; and
between the display name of the received electronic message and a display name stored in the at least one database of known addresses and of known display names.

15. The computing device of claim 11, further comprising prompting for a decision confirming the flagged electronic message is suspect or a decision denying that the flagged electronic message is suspect.

16. The computing device of claim 15, further comprising dropping the flagged electronic message when the prompted decision is to confirm that the flagged electronic message is suspect and delivering the flagged electronic message when the prompted decision is to deny that the flagged electronic message is suspect.

17. The computing device of claim 11, wherein accessing also accesses a database of blacklisted senders of electronic messages and dropping the received electronic message if the address of the received electronic message matches an entry in the database of blacklisted senders of electronic messages.

18. The computing device of claim 11, wherein the display names stored in the at least one database of known addresses and known display names are normalized and wherein the method further comprises normalizing the display name of the electronic message before quantifying.

19. The computing device of claim 18, wherein normalizing further comprises transforming the received display name to at least one of make all lower case, remove all punctuation and diacritical marks, remove bracketed or parenthetical information and extra spaces.

20. A tangible, non-transitory machine-readable data storage device having data stored thereon representing sequences of instructions which, when executed by a computing device, cause the computing device to:
receive an electronic message from a purported known sender over a computer network, the electronic message comprising an address and a display name;
access at least one database of known addresses and known display names and determine whether the address and the display name of the received electronic message match one of the known addresses and known display names, respectively, in the at least one database of known addresses and known display names;
quantify a similarity of the address and of the display name of the received electronic message to at least one address and to at least one display name, respectively, in the at least one database of known addresses and known display names;
determine the received electronic message to be legitimate when the address and the display name of the received electronic message are determined to match one of the known addresses and known display names, respectively, in the at least one database of known addresses and known display names;
flag the received electronic message as being suspect:
when either the address or the display name of the received electronic message does not match an address or a display name, respectively, in the at least one database of known addresses and known display names; and
when the quantified similarity of the address of the received electronic message is greater than a first threshold value or when the quantified similarity of the display name is greater than a second threshold value; and
generate at least a visual cue when the received electronic message has been flagged as being suspect, to alert a recipient thereof that the flagged electronic message is likely illegitimate.
